(19) United States
(12) Patent Application Publication
(10) Pub. No.: US 2025/0044758 A1
(43) Pub. Date: Feb. 6, 2025

(54) Device Detection in Process Control Systems

(71) Applicant: ABB Schweiz AG, Baden (CH)

(72) Inventors: Stefan Pook, Minden (DE); Thomas Keul, Freigericht (DE); Arthur Bebernik, Bueckeburg (DE); Huan Shi, Hangzhou (CN); Tina-TingTing Hong, Hangzhou (CN)

(73) Assignee: ABB Schweiz AG, Baden (CH)

(21) Appl. No.: 18/791,604

(22) Filed: Aug. 1, 2024

(30) Foreign Application Priority Data
Aug. 1, 2023 (EP) 23188985.8

(51) Int. Cl. G05B 19/042

(52) U.S. Cl. CPC G05B 19/042; G05B 2219/25257

(57) ABSTRACT

A controller for a process control system is configured to detect an adapter type of at least one adapter communicatively coupled to the controller, wherein the at least one adapter is for coupling at least one field device of an automation system to the process control system; to select a communications protocol according to the detected adapter type, wherein the communications protocol is for communicating with the at least one field device; and to communicate with the at least one field device using the selected communications protocol to control an industrial process carried out by the automation system.

### CROSS-REFERENCE TO RELATED APPLICATIONS

The instant application claims priority to European Patent Application No. 23188985.8, filed Aug. 1, 2023, which is incorporated herein in its entirety by reference.

### FIELD OF THE DISCLOSURE

The present disclosure generally relates to device detection in process control systems.

### BACKGROUND OF THE INVENTION

In the field of industrial automation, process control systems are used to control production processes carried out by production plants, e.g. in the process industry or automobile industry. During the process of designing and commissioning the plant, the process control system is provided with engineering data (using an engineering tool) defining relevant plant topology and a configuration for each of its fieldbus communications interfaces. The controller subsequently configures the fieldbus communications interfaces according to the engineering data, to enable subsequent communications with the associated field devices. Without such engineering data, the process control application remains in an idle state and no communication with the field devices takes place. The approach of configuring fieldbus communications interfaces using the engineering tool in this way is inflexible, complex, time-consuming, and error-prone.

### BRIEF SUMMARY OF THE INVENTION

To better address one or more of these concerns, in a first aspect of invention there is provided a controller for a process control system, wherein the controller is configured, in use: to detect an adapter type of at least one adapter communicatively coupled to the controller, wherein the at least one adapter is for coupling at least one field device of an automation system to the process control system; to select a communications protocol according to the detected adapter type, wherein the communications protocol is for communicating with the at least one field device; and to communicate with the at least one field device using the selected communications protocol to control an industrial process carried out by the automation system.

### BRIEF DESCRIPTION OF THE SEVERAL VIEWS OF THE DRAWING(S)

FIG. 1 is a diagram of a process control system in accordance with the disclosure.

FIG. 2 is a schematic of components of the process control system of FIG. 1 in situ.

FIG. 3 is a flowchart of an auto-configuration method for the process control system of FIG. 1.

FIG. 4 is a diagram of a computing system that can be used in accordance with the systems and methods disclosed herein.

### DETAILED DESCRIPTION OF THE INVENTION

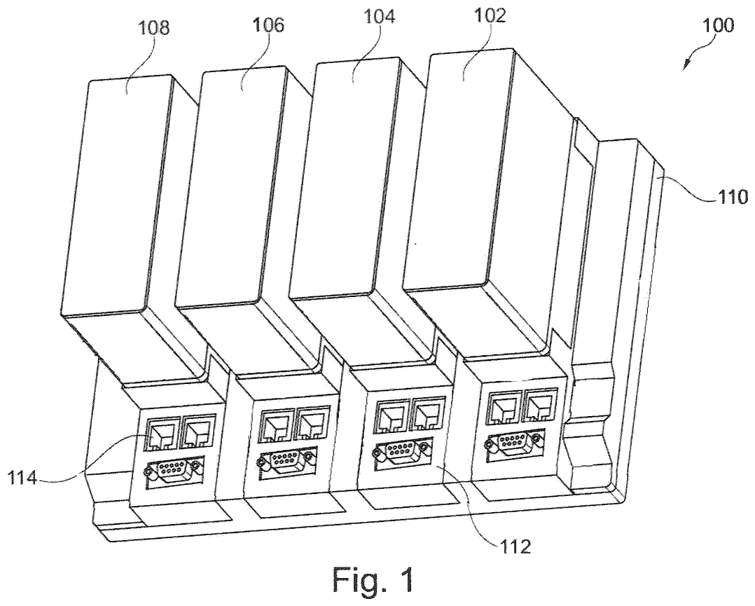

FIG. 1 illustrates a process control system 100 for controlling an industrial process carried out by an automation system (not shown). The process control system 100 comprises several different hardware units 102-108 physically and communicatively coupled to one another via a mounting termination unit (MTU) 110, commonly known as a backplane. The units illustrated in FIG. 1 include a standalone controller 102, a standalone fieldbus adapter 104 of a first type, a standalone fieldbus adapter 106 of a second type, and a controller 108 comprising an integrated fieldbus adapter. Each controller 102, 108 communicates with other components of the automation system, such as the engineering tool 200 described herein, over a control network. To that end, each controller 102, 108 is provided with network interfaces, such as that illustrated at 114, for communication via at least one Ethernet-based fieldbus. Whenever a controller is required to communicate with a non-Ethernet based fieldbus (e.g. PROFIBUS), a fieldbus adapter is required. The fieldbus adapter may be integrated into the controller unit, as in the case of controller 108, in which case no configuration by the engineering tool is required but no flexibility to add or change the fieldbus is afforded. Alternatively, the controller and adapter may be implemented as separate units, as in the case of units 102, 104, which provides flexibility in deployment but which requires the controller 102 to obtain configuration data.

The mounting termination unit (MTU) 110 comprises a number of slots for accommodating the units 102-108. Each slot is provided with an inlay 112 corresponding to the type of unit that will be accommodated in that slot. Each unit 102-108 can be detachably connected to the mounting termination unit 110 via the corresponding inlay 112. The mounting termination unit 110 may further comprise circuitry (not shown) for powering the units and/or for accommodating a power module.

Each controller 102, 108 is configured to control a respective process carried out by the automation system (not shown). The process control system 100 may find application in any field of industry where process automation is desired, such as energy, oil and gas, chemical, petrochemical, and so on. The controller 102, 108 handles process control and monitoring for the automation system by receiving input signals from sensors and instruments, and outputting control signals for controlling plant equipment such as pumps, valves, conveyors, mixers, and heaters. Any such sensor, instrument or plant equipment may form part of one or more of the field devices 202 described herein. The controller 102, 108 is configured to execute a process control application to generate the control signals on the basis of the input signals. The control application may comprise control logic instructing the controller 102, 108 how to respond to all input signals with appropriate control signals to maintain normal functioning of the process. In one non-limiting example, the control application conforms to the international standard IEC 61131.

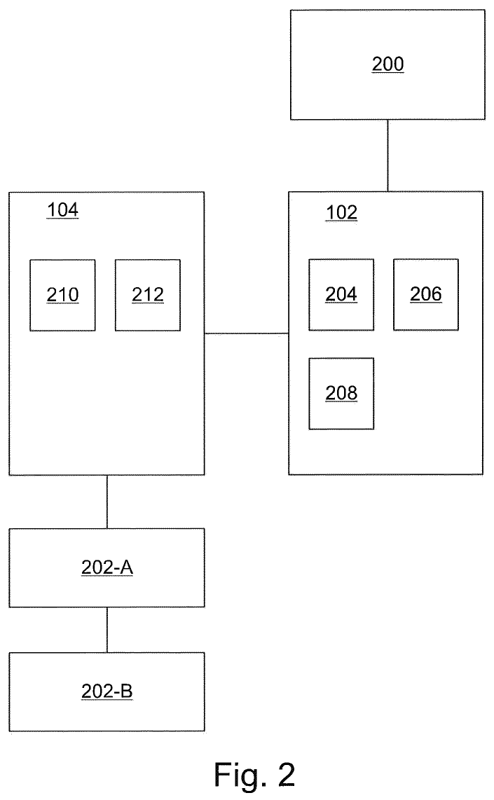

FIG. 2 schematically illustrates the process control system 100 in situ, that is, in communication with the engineering tool 200 and with one or more field devices 202, which in the non-limiting example depicted in the figure include field device 202-A and field device 202-B. For convenience, only the controller 102 and the adapter 104 are illustrated in FIG. 2.

The engineering tool 200 (typically implemented as a software package) is used to create configuration data for the process control system 100, which can be downloaded to the controller 102.

The controller 102 comprises logic circuitry 204 configured to execute the control application. The logic circuitry 204 may comprise a CPU, MCU, SoC, FPGA, DSP, and/or an AI-engine, together with any memory to be used in the processing of signals. The logic circuitry 204 may be further configured to perform any one or more of the other operations described herein.

The controller 102 further comprises a communications interface 206 for handling communications between the logic circuitry 204 and the fieldbus adapter 104.

The controller 102 further comprises power down circuitry 208 for handling power down sequencing in case of power loss.

The fieldbus adapter 104 comprises a fieldbus communications interface (FCI) 210 for interfacing with the field devices 202 over a communications network in the form of a fieldbus. The fieldbus communications interface 210 comprises fieldbus-specific transceivers and/or hardware drivers for the fieldbus protocol implemented by the adapter 104. The adapter 104 may be furthermore connectable to least one input/output (I/O) module for inputting signals from, and/or outputting signals to, the field devices 202.

The adapter 104 further comprises non-volatile storage 212 storing data including an identifier of the adapter 104.

One known workflow for configuring the process control system 100 involves using the engineering tool 200 to create configuration data for the controller 102, based on a known topology of the plant, and downloading the configuration data to the controller 102. The controller 102 is enabled to communicate with the field devices 202 via the fieldbus adapter 104 when executing the control application. One problem with this known approach is that installation faults may only become apparent once the control application is executing, which precludes early validation of the hardware installation. Stated differently, the control application must be prepared for testing before any validation of the installed hardware can take place, which complicates or hinders the plant engineering workflow.

The present disclosure thus envisages novel apparatus and methods which aim to simplify or rationalize the process control hardware and/or the plant engineering workflow.

Referring again to FIG. 2, the communications interface 206 of the controller 102 of the present disclosure comprises a universal communications interface 206 which is configured to communicate using a plurality of fieldbus protocols (e.g. PROFIBUS, CAN, MODBUS). More particularly, the universal communications interface serves as a fieldbus communications interface for each type of fieldbus protocol used by the field devices, in that it handles fieldbus-specific communications in layers 2 to 7 of each of the relevant fieldbus communication protocols. In one non-limiting example, the universal communications interface 206 comprises programmable logic circuitry, for example a field-programmable gate array (FPGA), optionally inside a system-on-chip (SoC). The FPGA is partitioned to support the plurality of fieldbus protocols. Following detection of the adapter type, the programmable logic circuitry may be reconfigured, for example by loading an appropriate configuration to the FPGA (without disturbing other channels) so as to load the correct protocol handler into the FPGA.

Furthermore, according to the present disclosure, the fieldbus adapter 104 takes the form of a fieldbus physical layer adapter 104 in which the communications interface 210 comprises a physical signal conversion unit 210 for handling (preferably only) communications in the physical layer (layer 1) of one specific fieldbus protocol, in order to implement the physical layer translation.

The fieldbus physical layer adapter 104 is configured to provide access to its hardware ID from non-volatile storage 212, for example when queried, whereby the logic circuitry 204 is able to identify the adapter 104 to determine which fieldbus protocol it uses. The logic circuitry 204 is furthermore able to configure the universal communications interface 206 to operate according to the fieldbus protocol used by the fieldbus adapter 104.

As mentioned herein, the adapter 104 is of a first type, that is, the adapter 104 implements the physical layer of a first fieldbus protocol, whereas the adapter 106 is of a second type, that is, the adapter 106 implements the physical layer of a second fieldbus protocol.

Thus, when the fieldbus physical layer adapter 104 of the first type (e.g. PROFIBUS) is mounted to the MTU 106, the universal communications interface 206 communicates using the first fieldbus protocol, whereas, when the fieldbus physical layer adapter 106 of the second type (e.g. CAN) is mounted, the universal communications interface 206 communicates using the second fieldbus protocol. In this way, the logic circuitry 204 is configured automatically to identify or recognize the (type of the) fieldbus physical layer adapter and to configure the universal communications interface 206 accordingly, without user intervention. Meanwhile, since communication in higher protocol layers is handled by the universal communications interface 206, the adapter 104, 106 need include only the physical layer conversion unit 210 and can thus be simplified by omission of circuitry for handling the higher layers of the protocol stack. The approach disclosed herein thus provides the possibility of performing bottom-up engineering for fieldbus adapters and/or fieldbus devices. The engineering process is simplified and fault detection in the actual installed hardware is expedited by having access to information (such as installed hardware, serial number, hardware/firmware revision etc.) from the fieldbus adapters and the fieldbus devices.

Following automatic configuration of the universal communications interface 206, the logic circuitry 204 may proceed to detect the available field devices 202-A, 202-B via the appropriately configured universal communications interface 206 together with the fieldbus physical layer adapter 104. The information so collected may be used to validate the hardware installation. The information collected from the fieldbus devices 202 can be used to determine the topology of the automation system. The collected information may be used for further purposes, such as: presentation of the actual hardware arrangement to the user to facilitate an overview of the health of the installed hardware; import of the actual hardware arrangement to the engineering tool 200, for example to expedite commissioning; consistency check involving comparing the detected topology to an expected topology obtained from the engineering tool 200.

In other instances, the logic circuitry 204 may refrain from accessing the fieldbus devices 202, e.g. to avoid disturbing the operation of other controllers or adapters.

Although the logic circuitry 204 and the universal communications interface 206 are illustrated in FIG. 2 as two separate units, it will be appreciated that they be implemented by the same unit or in a more distributed manner.

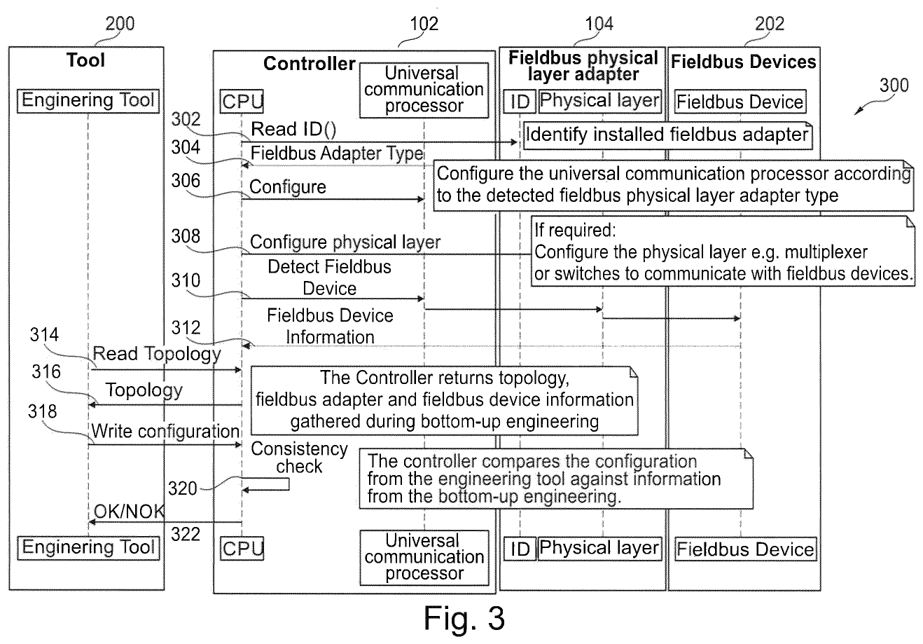

FIG. 3 illustrates an auto-configuration method 300 for the process control system 100. The method may be performed by the controller 102, and more particularly by the logic circuitry 204. The method begins at step 302 with the logic circuitry 204 reading the ID from the non-volatile storage 212 of the installed adapter 104 in order to identify it. At step 304, the adapter 104 returns its ID, which corresponds to a particular fieldbus adapter type. At step 306, the logic circuitry 204 configures the universal communications interface 206 according to the detected fieldbus physical layer adapter type. At step 308, the logic circuitry 204 optionally configures the physical signal conversion unit 210 of the adapter 104, if necessary (for example to configure a multiplexor or switches to communicate with fieldbus devices). At step 310, the logic circuitry 204 detects fieldbus devices 202 connected to the adapter 104 and thereby obtains fieldbus device information at step 312. Once the fieldbus device information has been obtained, the logic circuitry 204 may respond to a topology read request received from the engineering tool 200 (which may be received at any point in the sequence of operations prior to that shown in FIG. 3) by returning the topology at step 316, along with information characterizing the adapter 104 and field devices 202. In response to a request received from the engineering tool (200) at step 318, the logic circuitry 204 may perform a consistency check at step 320 to compare information obtained from the engineering tool 200 with the information obtained earlier in the auto-configuration process, following which it returns either a positive or a negative acknowledgement at step 322. The auto-configuration method may form part of a process control method comprising the further step of the controller 102 communicating with the field devices 202 using the detected fieldbus protocol to control an industrial process carried out by the automation system.

Any unit, module, circuitry or methodology described herein may be implemented using hardware, software, and/or firmware configured to perform any of the operations described herein. Hardware may comprise one or more processor cores, field-programmable gate arrays (FPGAs), application-specific integrated circuits (ASICs), application-specific standard products (ASSPs), system-on-a-chip systems (SOCs), complex programmable logic devices (CPLDs), etc. Software may be embodied as a software package, code, instructions, instruction sets and/or data recorded on at least one transitory or non-transitory computer readable storage medium. Firmware may be embodied as code, instructions or instruction sets and/or data hard-coded in memory devices (e.g., non-volatile memory devices).

If implemented in software, the functions can be stored on or transmitted over as one or more instructions or code on a computer-readable medium. Computer-readable media include computer-readable storage media. Computer-readable storage media can be any available storage media that can be accessed by a computer. By way of example, and not limitation, such computer-readable storage media can comprise FLASH storage media, RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal may be included within the scope of computer-readable storage media. Computer-readable media also includes communications media including any medium that facilitates transfer of a computer program from one place to another. A connection, for instance, can be a communications medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communications medium. Combinations of the above should also be included within the scope of computer-readable media.

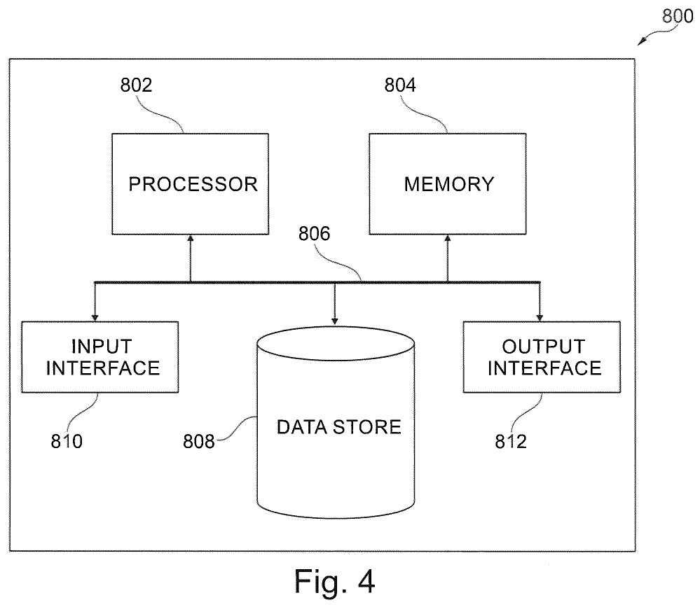

FIG. 4 illustrates an exemplary computing system 800 that can be used in accordance with the systems and methods disclosed herein. The computing system 800 may form part of or comprise any desktop, laptop, server, or cloud-based computing system. The computing system 800 includes at least one processor 802 that executes instructions that are stored in a memory 804. The instructions may be, for instance, instructions for implementing functionality described as being carried out by one or more components described herein or instructions for implementing one or more of the methods described herein. The processor 802 may access the memory 804 by way of a system bus 806. In addition to storing executable instructions, the memory 804 may also store conversational inputs, scores assigned to the conversational inputs, etc.

The computing system 800 additionally includes a data store 808 that is accessible by the processor 802 by way of the system bus 806. The data store 808 may include executable instructions, log data, etc. The computing system 800 also includes an input interface 810 that allows external devices to communicate with the computing system 800. For instance, the input interface 810 may be used to receive instructions from an external computer device, from a user, etc. The computing system 800 also includes an output interface 812 that interfaces the computing system 800 with one or more external devices. For example, the computing system 800 may display text, images, etc. by way of the output interface 812.

It is contemplated that the external devices that communicate with the computing system 800 via the input interface 810 and the output interface 812 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing system 800 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing system 800 may be a distributed system. Thus, for instance, several devices may be in communication by way of a network connection and may collectively perform tasks described as being performed by the computing system 800.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

It has to be noted that embodiments of the invention are described with reference to different categories. In particular, some examples are described with reference to methods whereas others are described with reference to apparatus. However, a person skilled in the art will gather from the description that, unless otherwise notified, in addition to any combination of features belonging to one category, also any combination between features relating to different category is considered to be disclosed by this application. However, all features can be combined to provide synergetic effects that are more than the simple summation of the features.

While the invention has been illustrated and described in detail in the drawings and foregoing description, such illustration and description are to be considered exemplary and not restrictive. The invention is not limited to the disclosed embodiments. Other variations to the disclosed embodiments can be understood and effected by those skilled in the art, from a study of the drawings, the disclosure, and the appended claims.

The mere fact that certain measures are recited in mutually different dependent claims does not indicate that a combination of these measures cannot be used advantageously.

Any reference signs in the claims should not be construed as limiting the scope.

Automatic device detection performed in relation to the adapter in this way enables the controller to begin communicating with the field device before any engineering data is received from an engineering tool, thereby reducing one or more of complexity, time expenditure, and susceptibility to error in the design and commissioning of the automation system.

In the embodiments described herein, the controller may further comprise a universal communications interface configured to serve as a communications interface in communications between the controller and the at least one field device, wherein the universal communications interface is configured to implement a plurality of communications protocols, and wherein the controller configures the universal communications interface to operate using the communications protocol that is selected according to the detected adapter type. The term “universal” may be taken to indicate that the communications interface is protocol-agnostic or a multi-protocol communications interface. The universal communications interface may be implemented as a universal communications processor.

Thus, the controller may be configured to select the communications protocol, and/or to configure the universal communications interface accordingly, without having any configuration from the engineering tool, that is, independently of any such configuration or before any such configuration is received. In this way, design and commissioning of the automation system may be further simplified, expedited, and made more robust.

The controller is configured to detect the adapter type by obtaining an identifier of the coupled adapter. The identifier identifies at least a type or class of the adapter. The identifier may comprise a serial number of the adapter. The identifier is associated with at least one communications protocol, such that the controller is able to determine, from the identifier alone, the at least one communications protocol used by the adapter. In one example, the controller obtains the identifier directly from the adapter, for example by reading the identifier from memory located in the adapter and/or in its inlay. In another example, detecting the adapter type may comprise detecting a type of the inlay, where the inlay type uniquely identifies the communications protocol to be used by the associated adapter type. In other examples, both the detector type and the inlay type may be used to determine the communications protocol. In other examples, trial-and-error using at least one standard read transaction may be used to determine the adapter type. By detecting the adapter type in any of the ways described herein, the controller is able to determine the communication protocol to be used without assistance from any external source, for example the engineering tool, such that the controller exhibits self-learning capability for ascertaining the communication protocol to be used.

The controller may be configured to detect coupling of the adapter to the process control system and to select the communications protocol in response to the detection of the coupling of the adapter. More particularly, the controller may be configured to detect coupling of the adapter to the process control system and to configure the universal communications interface to operate using the communications protocol in response to the detection of the coupling of the adapter. Coupling of the adapter to the process control system may take place during commissioning of the automation system or later during plant operation in the case that a preexisting adapter needs to be replaced. In one example, the controller is configured to detect coupling of the adapter by polling at least one predetermined address at which the adapter may be found, and ascertaining coupling in response to a response to the polling from the adapter. In such cases, the controller and the adapter may be configured to communicate via a standardized interface, such as an I2C interface in which the controller is master.

The controller may be further configured to detect the at least one field device communicatively coupled to the process control system via the adapter. Detecting the at least one field device may comprise using at least one protocol-specific device configuration protocol whereby field devices can be found without knowing their IP or MAC address. In one example, the protocol comprises the controller sending ping signals to predetermined addresses at which field devices may potentially be found and, based on device responses, generating a live list indicating which devices are to be found at which address, as in the case of PROFIBUS, for example. The controller may be configured to obtain field device information from the at least one field device. The field device information obtained from the at least one field device may comprise information identifying the at least one field device and/or indicating a type or class of the at least one field device. The field device information may comprise a serial number of the at least one field device. The field device information may indicate what hardware, firmware, and/or software is available at the field device.

The controller may be configured to determine a topology of at least part of the automation system based on the obtained field device information. The controller may be configured to validate the determined topology against an expected topology. The expected topology may be obtained from an engineering tool communicatively coupled to the process control system. Data regarding the determined topology and/or the detected devices may be communicated to, or made available to, the engineering tool and/or to a local diagnostic tool.

In any of the arrangements disclosed herein, the communications protocol selected by the controller may comprise a fieldbus protocol, e.g., PROFIBUS, CAN, MODBUS. By “protocol” is meant a system of rules or a predefined format for communications.

In any of the arrangements disclosed herein, the controller may be configured to perform a pre-check to ascertain that the adapter is not being used by another controller before using it.

In any of the arrangements disclosed herein, the controller may be configured to listen to the fieldbus before actively communicating on the bus to avoid disturbance to other devices such as an active controller.

In any of the arrangements disclosed herein, all interfaces between the controller (or, more particularly, its CPU) and the adapter may be media independent, where those between the adapter and the at least one field device may be media dependent (in the arrangement disclosed herein, the adapter implements layer 1 translation). By “media independent” is meant that different types of PHY devices (physical layer or layer 1 devices) for connecting to different network signal transmission media (e.g., twisted pair, fiber optic, etc.) can be used without redesigning or replacing the MAC hardware. In other words, any MAC may be used with any PHY, independent of the network signal transmission media.

In a second aspect, there is provided a process control method performed by a controller of a process control system, the method comprising: detecting an adapter type of at least one adapter communicatively coupled to the controller, wherein the at least one adapter is for coupling at least one field device of an automation system to the process control system; selecting a communications protocol according to the detected adapter type, wherein the communications protocol is for communicating with the at least one field device; and communicating with the at least one field device using the selected communications protocol to control an industrial process carried out by the automation system.

Any of the optional features or sub-aspects of the first aspect may be applied to the second aspect, mutatis mutandis.

The method of the second aspect may be computer implemented.

According to a third aspect, there is provided a computing system configured to perform the method of the second aspect.

According to a fourth aspect, there is provided a computer program (product) comprising instructions which, when executed by a computing system, enable or cause the computing system to perform the method of the second aspect.

According to a fifth aspect, there is provided a computer-readable (storage) medium comprising instructions which, when executed by a computing system, enable or cause the computing system to perform the method of the second aspect. The computer-readable medium may be transitory or non-transitory, volatile or non-volatile.

The invention may include one or more aspects, examples or features in isolation or combination whether specifically disclosed in that combination or in isolation. Any optional feature or sub-aspect of one of the above aspects applies as appropriate to any of the other aspects.

These and other aspects of the invention will be apparent from and elucidated with reference to the embodiments described hereinafter.

By “(process) automation system” is meant an industrial plant or production plant comprising one or more pipelines, production lines, and/or assembly lines for transforming one or more educts into a product and/or for assembling one or more components into a final product.

The term “obtaining”, as used herein, may comprise, for example, receiving from another system, device, or process; receiving via an interaction with a user; loading or retrieving from storage or memory; measuring or capturing using sensors or other data acquisition devices.

The term “determining”, as used herein, encompasses a wide variety of actions, and may comprise, for example, calculating, computing, processing, deriving, investigating, looking up (e.g., looking up in a table, a database or another data structure), ascertaining, and the like. Also, “determining” may comprise receiving (e.g., receiving information), accessing (e.g., accessing data in a memory), and the like. Also, “determining” may comprise resolving, selecting, choosing, establishing and the like.

The indefinite article “a” or “an” does not exclude a plurality. In addition, the articles “a” and “an” as used herein should generally be construed to mean “one or more” unless specified otherwise or clear from the context to be directed to a singular form.

Unless specified otherwise, or clear from the context, the phrases “one or more of A, B and C”, “at least one of A, B, and C”, and “A, B and/or C” as used herein are intended to mean all possible permutations of one or more of the listed items. That is, the phrase “A and/or B” means (A), (B), or (A and B), while the phrase “A, B, and/or C” means (A), (B), (C), (A and B), (A and C), (B and C), or (A, B, and C).

The term “comprising” does not exclude other elements or steps. Furthermore, the terms “comprising”, “including”, “having” and the like may be used interchangeably herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A controller for a process control system, wherein the controller is configured, in use:
to detect an adapter type of at least one adapter communicatively coupled to the controller, wherein the at least one adapter is for coupling at least one field device of an automation system to the process control system;
to automatically select a communications protocol according to the detected adapter type, wherein the communications protocol is for communicating with the at least one field device; and
to communicate with the at least one field device using the selected communications protocol to control an industrial process carried out by the automation system.

2. The controller of claim 1, further comprising a universal communications interface configured to serve as a communications interface in communications between the controller and the at least one field device, wherein the universal communications interface is configured to implement a plurality of communications protocols, and wherein the controller configures the universal communications interface to operate using the communications protocol that is selected according to the detected adapter type.

3. The controller of claim 1, wherein the controller is further configured to detect the adapter type by obtaining an identifier of the coupled adapter or an identifier of an inlay for the coupled adapter.

4. The controller of claim 1, wherein the controller is further configured to detect coupling of the adapter to the process control system and to select the communications protocol in response to the detection of the coupling of the adapter.

5. The controller of claim 1, wherein the controller is further configured to detect the at least one field device that is communicatively coupled to the process control system via the adapter.

6. The controller of claim 1, wherein the controller is further configured to obtain field device information from the at least one field device.

7. The controller of claim 6, wherein the controller is further configured to determine a topology of at least part of the automation system based on the obtained field device information.

8. The controller of claim 7, wherein the controller is further configured to validate the determined topology against an expected topology.

9. The controller of claim 8, wherein the expected topology is obtained from an engineering tool communicatively coupled to the process control system.

10. The controller of claim 1, wherein the selection of the communications protocol according to the detected adapter type takes place before the controller receives any configuration or topology information from an engineering tool, or independently of any such configuration or topology information received prior to the selection.

11. The controller of claim 1, further comprising logic circuitry configured to execute a control application for controlling the industrial process carried out by the automation system.

12. The controller of claim 1, wherein the controller is configured to be communicatively coupled to the at least one adapter via a mounting termination unit of the process control system.

13. A process control method performed by a controller of a process control system, the method comprising:
detecting an adapter type of at least one adapter communicatively coupled to the controller, wherein the at least one adapter is for coupling at least one field device of an automation system to the process control system;
selecting a communications protocol according to the detected adapter type, wherein the communications protocol is for communicating with the at least one field device; and
communicating with the at least one field device using the selected communications protocol to control an industrial process carried out by the automation system.

14. The process control method of claim 13, further comprising providing a universal communications interface configured to serve as a communications interface in communications between the controller and the at least one field device, wherein the universal communications interface is configured to implement a plurality of communications protocols, and wherein the controller configures the universal communications interface to operate using the communications protocol that is selected according to the detected adapter type.

15. The process control method of claim 13, further comprising detecting the adapter type by obtaining an identifier of the coupled adapter or an identifier of an inlay for the coupled adapter.

16. The process control method of claim 13, further comprising detecting coupling of the adapter to the process control system and selecting the communications protocol in response to the detection of the coupling of the adapter.

17. The process control method of claim 13, further comprising detecting the at least one field device that is communicatively coupled to the process control system via the adapter.

18. The process control method of claim 13, further comprising obtaining field device information from the at least one field device.

19. The process control method of claim 18, further comprising determining a topology of at least part of the automation system based on the obtained field device information.

20. The process control method of claim 19, further comprising validating the determined topology against an expected topology; wherein the expected topology is obtained from an engineering tool communicatively coupled to the process control system.
